(19) United States
(12) Patent Application Publication
(10) Pub. No.: US 2023/0373240 A1
(43) Pub. Date: Nov. 23, 2023

(54) WALL COVERING PANELS, A METHOD OF MANUFACTURING SUCH, AND METHODS OF TEST ADHERING SUCH PANELS TO A SURFACE, REMOVAL THEREFROM AND REPOSITIONING

(71) Applicants: Neil McCallum, Chicago, IL (US); Marie-Claire Girardi, New Berlin, WI (US)

(72) Inventors: Neil McCallum, Chicago, IL (US); Marie-Claire Girardi, New Berlin, WI (US)

(21) Appl. No.: 18/320,556

(22) Filed: May 19, 2023

Related U.S. Application Data
(60) Provisional application No. 63/344,139, filed on May 20, 2022.

(51) Int. Cl. B44C 5/04; B44C 1/10

(52) U.S. Cl. CPC B44C 5/0461; B44C 1/105

(57) ABSTRACT

A panel for decoratively covering a surface is provided. The panel comprises a section made of either a tile, such as a vinyl tile, or wallpaper. The section is sized as a small rectangular section, for easy handling. The panel comprises a decorative front portion, an adhesive applied to the rear side of the decorative front portion and an adhesive protection cover applied to the adhesive and forming part of the retail packaging of the panel. The adhesive protective cover is created in two portions, a large portion to cover substantially most of the rear side of the panel and a crack and peel strip, attached to the large portion and covering the adhesive. Both portions being removable to allow the panel to be adhered to a surface; the strip being separately removable to allow for the temporary placement of the panel to allow for easy correction of its placement, prior to the remaining portion of adhesive being exposed for permanent placement.

### FIELD OF THE INVENTION

The present invention concerns surface covering panels. More particularly the present invention concerns removable and replaceable wall panels, or coverings including vinyl sheets and sheets that are not made of vinyl, for application to a surface that are simple to apply while avoiding reposition challenges, are recyclable, and are reasonably priced.

### BACKGROUND OF INVENTION

Removable vinyl wallpaper has long been a popular facing material for walls and surfaces in long, cumbersome rolls that are extremely difficult to handle and aggressively engineered to bond and adhere to a wall. There is common belief by the general public that removable vinyl wallpaper does damage to the wall, is harmful to the environment and is difficult to install. They are available in many weights and textures, adhesive strengths, adhesive formulations, and adhesive coat weights. They are uniquely suited for a variety of applications ranging from decorative coverings for the home wall surfaces to sterile hospital operating rooms.

However, as stated above, the current state of the art has many short-comings, including making it difficult for do it yourselfers or people living in rentals, mobile homes; or simply anywhere that makes using such products too costly and difficult to install. People just give up and live with what they have. The current state of the covering art does not allow for easy placement and does not allow for an efficient means to apply, remove whenever desired and then reapply without damaging the surface and without the need for additional adhering, adhesive or sticking means.

In order to overcome these shortcomings, we have invented a coated sheet, for use as protective wall, cabinet, counter, or other surface covering; the sheet comprises a printed, coated, sealed sheet for use in an easy-to-install method of applying the sheet to a surface. The device includes a release liner system that additionally provides packaging rigidity and stiffness. The release liner system can also function as a device application guide to properly level, orientate, align the panel for placement (application), while ensuring protection of the adhesive during application and re-application. It will be understood that the sheeted material is suitable for use as wallpaper, notebook covers, book shelving covers, furniture resurfacing as well as for use on ceilings and as posters, craft projects, wall calendars and the like. Peel and stick wallpaper panels can be commonly referred to as wall tiles, “Peel N Stick” wall coverings, wallpaper sheets, removable wall tiles, removable wallpaper. No limitation on the naming of such products is intended by the use of this listing of names.

The present invention is a wall and surface covering and the specifications for manufacturing as well as applying the coverings. The present invention relates to both a wall tile, that is commonly generally square shaped, and a wallpaper sheet, that can be rectangular in shape. However, it will be understood that the tile or wallpaper sheet of the present invention can be made to any dimensions, sizes and shapes. Wall covering materials are typically proprietary pressure sensitive materials composed of specific release liners, adhesive formulations and coat weights, and are of custom engineered face stock materials. Such are produced by coating and laminating processes that marry adhesive, face sheets, and release liners together to form the device for application. Typically, these materials are printed using standard offset, flexographic (sometimes referred to as “flexo”), digital and rotogravure printing processes. High-pressured embossing is a common finish/conversion to give unique dimensional impact of the paper wall covering. The preferred mode of printing (manufacturing) the wall tile is offset printing, while the preferred mode for the wallpaper sheets has been found to be flexographic. Such methods create environmental issues in that the methods of creation are environmentally hazardous or effecting; further, the materials used are typically unavailing to the application of such to the surfaces to which they will be adhered.

Therefore, as will be described, in greater detail below, the present invention provides an environmentally friendly wall covering solution that can be easily assembled and applied to almost any wall or surface. Moreover, due to the structural rigidity of the face sheets, devices of the present invention avoid the typical ‘air-bubbling’ often occurring in more elastic and limp removable vinyl tile or wallpapers. As a result, this invention achieves greater adhesion to finish surface, eliminates the unsightly air-bubbles effect that plagues the prior-art. The overall impact is a lower initial adhesive tack, easier adhesive release and more undamaged walls that keep their finish intact. It also results in an inexpensive way to apply and then remove and reapply the tile or wallpaper to another surface or more accurately to the same surface. Further, another critical inventive feature of the present invention is that, the tile or wallpaper sheets use a peel-away strip, covering only a small area of its entire adhesive surface, so as to allow the user to peel the strip away and adhere the covering, by means of only part of the provided adhesive surface. In this manner, the device is lightly attached to a surface to be decorated, as a means of testing the product to see if the user likes the placement without having to adhere the entirety of covering pieces to the surface, or use other means, such as tape, to create a temporary Tack. Further, as will be seen below, the peel-away strip that reveals only a small portion of the adhesive, allows the user to more accurately lay out and apply the covering by being able to center and level one or more initial pieces, similar to the technique used by ceramic tile installers, by only revealing a small portion of the entire adhesive surface of each piece. Subsequently, the user may peel the remaining covering off of the covering and press the covering in place, without removing the covering from its initial placement, should that placement have been found to be acceptable.

### SUMMARY OF THE INVENTION

In accordance with the present invention, a panel for covering a surface, comprising a decorative cover portion as a front for displaying on a surface, is provided. The panel includes an adhesive portion, applied to the back of the cover portion and an adhesive protection cover, protecting the adhesive portion from permanent attachment to a surface before adhesion is desired. The adhesive protection cover is made in two parts, a general surface cover for protection of substantially all of the back of the panel and a strip portion, covering the remainder of the back panel and which can be removed from the panel, independent of the general surface cover, to expose only a small portion of adhesive. The surface on which the panel will be placed is typically a wall made of painted sheet rock. In a preferred embodiment, the adhesive is a press and apply type of adhesive such as low Surface Energy silicone. The panel can be a section of wallpaper or a vinyl-type tile.

In some embodiments, the vinyl element of the tile has a thickness of between 3 mil. and 5 mil., preferably 3.92 mil. The entire tile having a thickness of between 10 mil and 12 mil. The panel of the present invention will preferably be registered to permit the proper placement of a design made from two or more panels. The adhesive protective cover of the panel comprises a crack and peel portion to allow only a small section of adhesive to be revealed such that the panel can be temporarily placed on a surface and subsequently removed therefrom. The remaining adhesive remaining covered and protected until put into use when the device is finally located and placed. In a preferred embodiment the adhesive used to attach the panel has a lower Tack to allow for placement and removal prior to final placement; the adhesive gaining strength after placement and over time. In a preferred embodiment, the panels are sized at either 11″×16″ or 16″×24″ and have a generally 3.92 mil vinyl face stock and a liner of generally 3.92 mil clear PET liner. It will be understood that variations in the size and thickness of the panels can be made without departing from the novel scope of the present invention.

Preferably, the adhesive protection cover of the panel, comprises part of the retail packaging for the panel; acting as the back surface of the package, to provide a more sustainable use of materials. In a preferred embodiment, instructions for placement and use and details of manufacturing, materials and purchase price or bar code, or other information, is printed on the adhesive protection portion.

In the preferred embodiment, then, a panel for covering a wall, comprising a registered pattern decorative cover portion as a front for displaying on a surface is provide with an adhesive cover, comprising a lower Tack press and apply type adhesive, applied to the back of the cover portion. The adhesive protection cover protects the adhesive portion from permanent attachment to a surface before adhesion is desired and comprises a surface of the retail packaging for the panel. The adhesive protection cover is made in two, or more, parts comprising at least a general surface cover for protection of substantially all of the back of the panel and a strip portion, created as a crack and peel strip, covering the remainder of the back panel and which can be removed from the panel, independent of the general surface cover, to expose only a small portion of adhesive.

The panel is comprised of either wallpaper or tile, including vinyl tile. The vinyl tile, in this embodiment, has a thickness of between 2.25 mil and 5 mil. The panel is sized at either 11″×16″ or 16″×24″, and has a generally 3.92 mil vinyl or paper face stock and a liner of generally 3.92 mil clear PET liner. The adhesive protection portion comprises a listing of instructions for placement of the panel on a surface. Variations of the sizes and thicknesses of the panels can be made without departing from the novel scope of the present invention.

A more detailed explanation of the invention is provided in the following description and claims and is illustrated in the accompanying drawings.

### BRIEF DESCRIPTION OF THE DRAWINGS

FIG. 1 is plan view of a package of wall tiles made in accordance with the present invention.

FIG. 2 is a plan view of a segment of wall covering.

FIG. 3 is a side view of a wall tile segment and packaging of FIG. 1

FIG. 4 is a side view of the segment of wall covering of FIG. 2.

FIG. 5 is a plan view of a step in removing the tile of FIG. 1 from its packaging.

FIG. 6 is a plan view of a step in removing the tile of FIG. 1 from its packaging.

FIG. 7 is a plan view of the wall covering of FIG. 2.

FIG. 8 shows the removal of the adhesive covering from the wall covering of FIG. 2.

FIG. 9 is a view of the rear of the tile of FIG. 1.

FIG. 10 is a view of the rear of the wall covering of FIG. 2.

FIG. 11 is a view of the rear of the covering of FIG. 2, showing a section of the covering removed.

FIG. 12 is a view of the rear of the covering of FIG. 2, showing the manner of removal of a prescribed section of the covering.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiment”) relates to a requirement of the United States Patent Office, and should not be found to limit the subject matter disclosed herein.

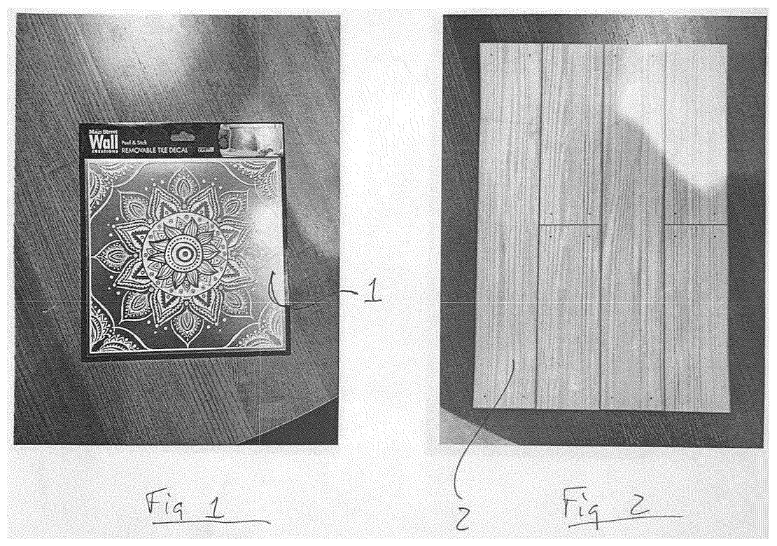

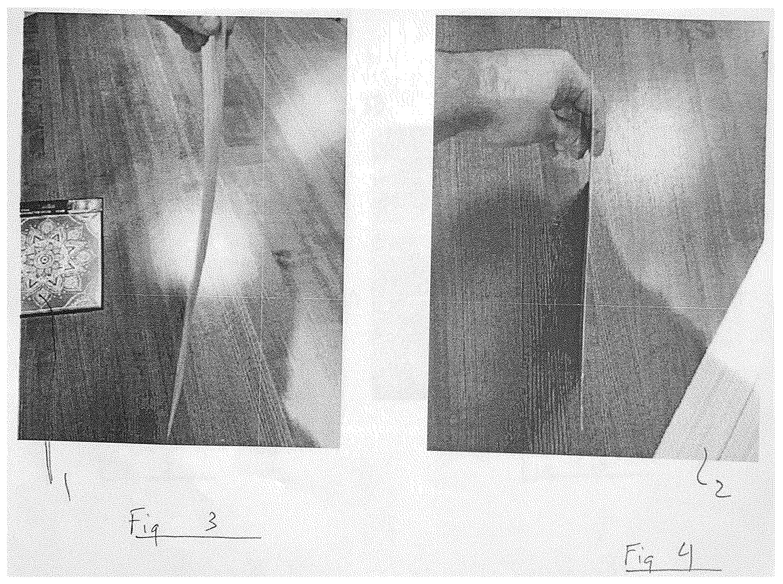

Referring now to the attached drawings, FIG. 1 shows an example of the wall tile 1 disclosed herein while FIG. 2 shows an example of the wallpaper 2. It will be seen that tile 1 is shown here as a regular square but it should be appreciated that tile 1 can be of any shape such as a rectangle, circle, trapezoid—the exact shape, dimensions, size and particular design are not important and not meant to be a limitation. Tile 1, as seen in FIG. 3, is of a greater thickness than typical wallpaper and is effective not only to cover the wall decoratively, but also to overcome any small imperfections of the wall as its thickness permits tile 1 to span over divots or small holes in the wall surface. Similarly, wallpaper 2 is shown as a rectangle and is elongated and larger overall than tile 1 so as to cover more surface area per application of each individual piece, but again the exact shape, dimensions, size and particular design are not meant to be a limitation. The coverings tile 1 and wallpaper 2 can be printed with a limitless type of designs, colors or artwork. FIGS. 3 and 4 show the current coverings, respectively tile 1 and wallpaper 2, from the side to illustrate the typical desired thinness of the coverings. While FIGS. 3 and 4 show the side of the tile, the below illustration shows the various layers making up tile 1 and wallpaper 2:

Illustration of layers making up
the device of the present invention.

| | |
|---|---|
| .75 metPET | A |
| Permanent Adhesive | B |
| 10 pt TagStock | C |
| Removable Adhesive | D |
| 3.4 mil Layflat Liner | E |

As can be seen, a display element A, the part of the device that is visible when the device is installed, is attached by a permanent adhesive layer B to a supportive stock element C. Adhesive D, as described herein, allowing for the placement, removal and replacement of the device on a surface, is attached to the combined layers A, B and C and is protected by a peel-away liner covering E, which will be described in greater detail below. Using the current technique and method of making these coverings allows for this extremely thin product that allows the coverings to be easily cut, further shaped (for example by cutting to a desired size and shape using ordinary household tools, such as a scissor) and applied by the user.

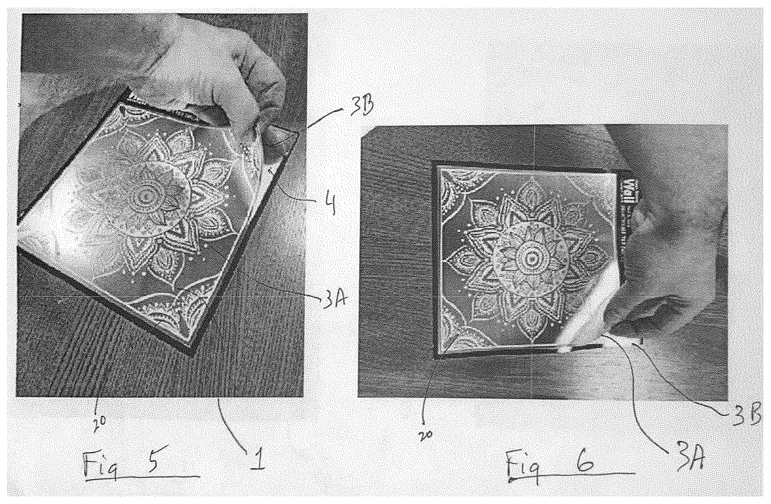

Referring now to FIGS. 5 and 6, the removal of wall tile 3A from packaging is shown. The user, in removing tile 3A from packaging 20 is actually peeling away the liner sheet 3B, which also forms the outer surface of the packaging 20 used to house tile 3A. Sheet 3B is what holds tile 3A and allows the product to be shipped and displayed in a store. The back of tile 3A comprises the layer, or application, of adhesive 4 which allows tile 3A to be applied to whatever surface the user decides to apply tile 1.

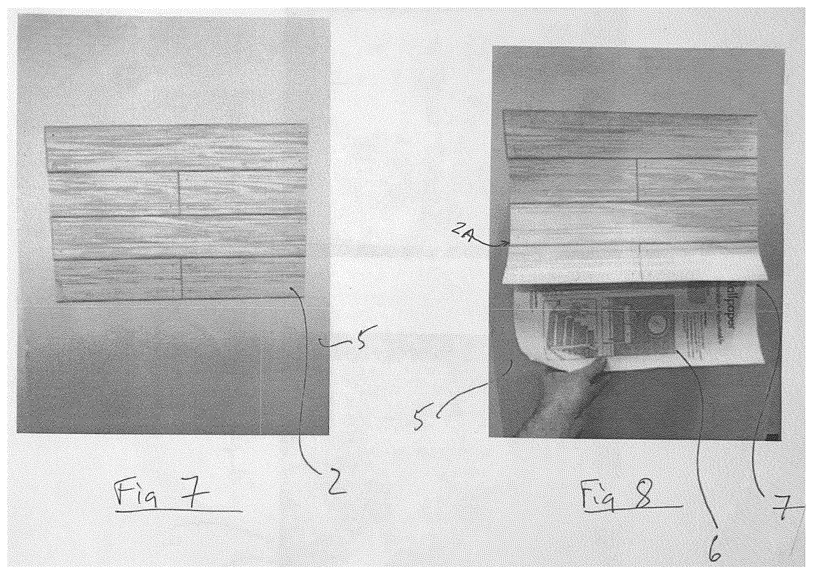

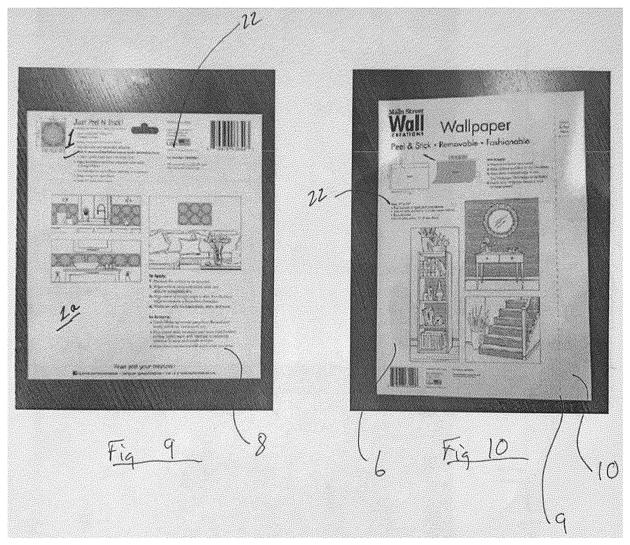

FIGS. 7 and 8 show the other type of covering, namely wallpaper 2. FIG. 7 shows wallpaper 2 as applied to a surface 5, here shown as a wall 5. FIG. 8 shows the backing or back surface 6 being peeled away along point 7 from wallpaper 2. FIG. 9 shows rear surface 1a of wall tile 1; showing a backing or back surface 8—as will be understood back surface 8 is the backside of sheet 3B described above, back surface 8 houses or holds the tile, to be applied, 3A. Additionally and inventively back surface 8 further includes space for the inclusion of application and use instructions 22, for how to use and apply, and how to later remove, wall tile 1. Similarly, FIG. 10 shows a more complete view of backing 6, which houses or holds wallpaper 2 to be applied to a surface when it is peeled away or off the backing 6. The back surface 6 also includes the instructions 22 for how to use and apply, and subsequently remove, wallpaper 2.

Further, and most importantly as shown best in FIGS. 10, 11 and 12, is partial peel-away strip 10. Partial peel-away strip 10 is demarcated by slits 9 that are configured to the surface of backing 6 so as to allow for just strip 10 to be peeled off of wallpaper 2, to expose only a portion of the backside 2A (FIG. 8) of wallpaper 2 exposing the adhesive means. This ability to peel away only a portion of the backside allows the user to test out the placement and style of a particular covering on the surface upon which the covering is to be applied and in this way position the coverings later for more permanent placement before fully peeling away backing 6. This feature allows the user to play with the covering to see it if actually works for them in terms of size, design and other elements of style. It gives the user the freedom to test style and placement before committing to a particular design or application without fully peeling the peel-away backing 6. Although the coverings of the present invention are also ultimately designed to be applied and removed and reapplied, this special partial peel-away feature provides the use with more flexibility and ability for test and for making sure that the pattern matches (registers) throughout.

The preferred embodiments of this inventive covering are envisioned to be sheeted material of an 801b paper face stock, 10 pt tag stock, polypropylene, polyethylene, polyolefin. Or other film-based materials, as known to persons having ordinary skill in the art. These face sheets are married to a siliconized release liner coated with a removable adhesive. The face sheet is laminated to the face of the removable adhesive and release liner. Through later finishing conversion processes the release liner is die-cut to provide an easy “Crack N Peel” applicator. This applicator vastly improves the ease of application of removable wall coverings. This feature along with and in combination with the low Tack removable adhesive allows for simple layout of the coverings or tiles on finished surface. The user can easily center, level, judge and confirm the positioning as needed. If the user is not satisfied with the location or angle, then they can simply remove the applicator portion of the removable wall covering from the finished surface, mark the surface and apply the covering in a new location. Through this process the majority of the covering's adhesive is preserved and a high efficacy rate is still achieved. This method of adhesive preservation allows this covering to maintain a lower Tack adhesive that will not damage consumer's walls or floors or whatever surface they are covering even after years of adhesion. This is unlike most currently available removable vinyl wallpaper products in the marketplace today.

In a preferred embodiment of the invention, the tiles are made of 3.92 mil vinyl face stock and the wallpaper sheet of 3.92 mil clear polyethylene terephthalate (PET). As is known to persons having ordinary skill in the art, PET is the most common thermoplastic polymer resin of the polyester family and is used in fibers for clothing, containers for liquids and foods, and thermoforming for manufacturing, and in combination with glass fiber for engineering resins. The liner of these products doubles as packaging, in the form of a “crack & peel” die cut element that allows for easy liner removal and wall application, as will be explained below. The PET liner has been precoated with a silicone release coating, which has been cured to become inert and stable. The selection of silicone used has been designed to provide a very low Surface Energy on the coated side of the PET. This is often referred to as siliconized release liner. It will be understood that the term surface energy can be defined as the work per unit area done by the force that creates the new surface. The new surface can be measured in dyne/centimeter, or Newton/meter.

The PET film used to create the liner is typically silicone coated in a roll-to-roll process, with the PET film roll unwound, coated and dried/cured with silicone and then the coated PET wound into a roll for further processing. The silicone coating is applied at very low weight and the silicone does not adhere to the non-coated side of the PET film.

It will be understood that the art of coating methods used for the silicone, the types of silicone used herein, the applied weight, the methods for drying and/or curing and unwinding and rewinding, methods for determining dryness or degree of curing are well known to persons having ordinary skill in the art. In addition, methods are described, in the art, to measure applied silicone weight, continuity of coating and surface energy to ensure design specifications are met.

In the present invention, low Surface Energy silicone has been selected to allow, in another coating process, further wetting and coating of the liquid Pressure Sensitive Adhesive (PSA). After drying the PSA forms a continuous layer the adheres with low bonding force to the silicone layer. The PSA side of the coated PSA is further laminated in the same process pass to the plain vinyl face stock or the unprinted side of the preprinted vinyl face. This lamination of PET-silicone release coating-PSA-vinyl face stock is then wound into a continuous roll. While particulars of the PSA coating method are not important to the invention, there are many patents in the art of PSA coating methods, applied weights, drying, and lamination to various face stocks. Also, methods are described to measure applied PSA coating weight, dryness, adhesion the silicone layer, adhesion to the face stock and other design parameters to ensure that the specifications for the application are met.

In a preferred “factory formula”, the adhesive is considered “removable” due to the formulation. It will be understood that the formulation can be based either on a removable formulation or a lighter coat weight on a permanent formulation; with similar effect. In a preferred embodiment, the PSA selected is designed through formulation, chemistry and type to be removable or repositionable. The bonding of the PSA is of sufficient force to have near instant ‘grab’ or adhesion to the recommended wall surface, yet be easily removed or adjustment of the vinyl tile, alignment or registration to other printed tiles. Once in final position, the bonding will continue to increase until a design target of bonding force is reached, in minutes, or hours or days, which has been predetermined to hold the tile in place without lifting, curling or falling from the wall. The removability property of the PSA is usually determined by formulation. As will be understood by persons having ordinary skill in the art, a target applied weight of PSA is usually specified for an application. The bonding force is determined by the formula to meet the desired target force and time to achieving that force. The force of adhesion is slightly influenced by applied coating weight: lower applied weight lessens the bonding force slightly; higher coating weight increases the bonding force slightly. Here, the formulation of the PSA has been designed to remain adhered to the vinyl face stock with much higher bonding force than the PSA adhering to the wall surface. The formulation has also been designed to have no transfer of PSA or PSA residue to the wall surface, so as to create a clean removal, in order not to mar, contaminate or lift the coated surface of the wall (usually interior type paint).

As will be understood, the smoothness and chemical makeup also influences the bonding force. Rougher or textured wall surface may have a lower bonding force of the PSA at a given PSA coating weight compared to a smooth wall. Further, certain paints have polymers or additives that enhance washability, that may interfere with the bonding of the PSA.

This covering can be applied by the novice decorator, which thereby eliminates the need for expensive tradesmen to finish the walls, flooring or other surface of the home, work area, or any venue. Paper and Poly face sheet materials are rigid in nature and are meant for single use, unlike typical elastic vinyls. The coverings of the present invention make it cost-effective and easy to use, which therefore appeals to impulse purchases, to crafters and do it yourselfers (DIY), because these materials can be purchased inexpensively and are easy to use. It is envisioned that these covers can be used not only in the traditional manner for walls or floors, but wherever they can be applied, meaning on furniture or wherever the user wants to accessorize such as with artful craft and broad décor projects. It is a simple, inexpensive means to jazz up any surface. Many refer to this as “shabby-chic”—which makes decorating accessible to everyone.

For aid in application, the wallpaper of the present invention is “registered” in order to ensure that the pattern will match when laid next to any duplicate piece of the same size and design, allowing for easy application. That marking is done in the print process. Also allowing for easy application, is the “crack and peel” die cut on the liner; which allows end users to bend at the crack, break the release liner along the die cut, and easily peel the smaller strip of release liner off first, thus exposing a smaller area of PSA adhesive for easier placement and reduced likelihood of inadvertent sticking to the wall. The liner is designed by Chartwell Studio of Chicago, Illinois. With respect to the smaller strip of adhesive exposed, due to the small area of exposed PSA, compared to the balance of the tile, the bonding force is relatively low to the wall. Thus, the tile can be peeled from the wall in case of misalignment, lack of levelness or misregistration. However, once the placement is correct and as desired, the small area of the PSA exposed tile is then more forcefully pressed to the wall and the balance of the release liner, covering the balance of the PSA on the tile, is slowly removed to allow the tile adhesive to be pressed to the surface. The balance of the PSA thus exposed can then be pressed to the wall, allowing the first small area bonded previously, to hold the tile in alignment, levelness and registration until the balance of the adhesive is exposed and pressed to the surface.

Another aspect of the present invention is the type and manner of creating desirable wall surfaces. In a preferred embodiment of the present invention, flexographic printing is used to create the wallpaper surface, while offset printing is used to create the tile surface. As will be understood by persons having ordinary skill in the art, there are many methods of creating decorative panels and there are a plethora of patents describing the art of flexographic, digital and rotogravure printing in the literature. The preferred method of the invention is flexographic printing which is preferred for several reasons, including, but not limited to the following:
a. Flexography is a roll-feed web printing process. Flexographic printing is commonly used to print high volumes of labels and packaging. Presses can print on a variety of films, foils, papers, corrugated board, and paperboard and achieve speeds of between 500 to 2000 feet per minute.
b. Products printed on “flexo” presses include adhesive and shrink-sleeve labels (bottle wraps); ice cream cartons; folding cartons; shopping bags; plastic bags; pouches; packets; gift wrap; tissue; envelopes; wallpaper; and disposable plates and cups.
c. A flexible, photopolymer plate is wrapped around a rotating cylinder for each color. Like the letterpress printing process, the graphics and text for each color are raised from the surface of the plate. Only the raised areas of the plate are inked.
d. Flexographic printing can be used to print solid colors and patterns on a wide range of substrates, including materials that are porous, non-porous, flat, rough, absorbent and non-absorbent. In addition, if a central impression (C.I.) configuration is used for the print setup, it allows for superior color-to-color registration on extensible substrates.
e. Flexographic printing is known for being a fast process. Once the initial setup is complete, the combination of quick-drying inks and automation result in very high performance. In addition, this method gives the users the possibility to preset the amount of ink used in the printing process.
f. Flexography allows the use of numerous ink types for the printing process. They are also chosen according to the type of application and the processes that follow the printing (ultra violet, heat sealing, lamination, etc.). However, it is crucial to select the ink primarily based on the final product desired, in the present invention, ultra-violet (UV) curability is an important aspect and the basis of the choice for a preferred embodiment.
g. Ink drying is another important factor in the printing process. Flexography makes it possible to use inks with a lower viscosity, allowing the printed images to dry more quickly. Finally, flexographic printing requires low ink consumption.
h. Flexography printing has lower operating costs than other printing methods. This is due to the lower cost of materials (the ink is less expensive and the plates are inexpensive to replace), the durability of the plates (which it has been found, last for millions of impressions), and the lower labor cost given by the fewer steps needed for the printing process.

One aspect of prior tile placement processes is air-bubbling within the placed wall covering. For this reason, the rigidity of a wall tile, in comparison with wallpaper and other coverings, is that tiles are rigid, preventing bubbling. It will be understood that the vinyl tile is flexible enough to bend, as it is being applied by the PSA coated side, but rigid enough to not form bubbles (caused by poor placement of very flexible coverings). With care and proper technique, by the user, air bubbles trapped between the PSA side of the tile and the wall can be avoided. If bubbles are trapped behind the tile, the tile can be lifted again due to the removable characteristic of the PSA, and reapplied to avoid or minimize air bubbles. The vinyl tile is also rigid enough to minimize or prevent lifting to avoid air bubbles from forming or, if small bubbles, showing through the tile.

The preferred embodiment of the present invention is designed to allowing for easy application by means of a “crack and peel” die cut on the liner that protects the adhesive. By providing a small portion of a the liner to be removed to expose the adhesive the tile and/or wallpaper, can be affixed to the wall, lifted and replaced all without damaging the majority of the adhesive in the placement process, and while keeping the adhesive sheet from collapsing onto itself like rolled vinyl removable wallpaper. This feature allows end users to bend the small portion of the release liner at a manufactured crack in the liner, break the PET release liner along the crack and easily peel the smaller strip off first, thus exposing a smaller area of adhesive for easier placement and reduced likelihood of inadvertent sticking to the wall. The preferred liner is designed by Chartwell Studio of Chicago, Illinois.

Some issues associated with the application of wallpaper and other coverings will be described to provide a foundation for the innovations of the present invention. As is commonly known, traditional wallpaper required the hiring of professional installers as the complexity of matching the pattern as it is applied coupled with the difficulties of applying adhesive to the paper and then adhering it correctly, both straight, in line with the pattern and not having air bubbles appear in the paper, required the practiced touch of a professional. And, while it is still recommended that professionals be used to apply the coverings of the present invention, it will be see that the wallpaper of the present invention can easily be installed by a novice “do-it-yourselfer” because of the inventive elements of the wallpaper, as described herein.

Once adhered to the wall, traditional wallpaper is later difficult to remove and often is left as the base for either an application of new wallpaper or is painted to cover up the design; looking unprofessional and perpetuating prior mistakes made in application. Those having experience in wallpaper situations know that it can take days to remove standard wallpaper form a room, and the removal can, and often does, leave behind damage to walls or at the very least extra adhesive that needs to be cleaned from the wall, prior to preparing the wall for either new paper or paint. Removable rolled wallpaper, as provided in the present invention can be quickly and easily removed at any stage (at time of placement, after several days with regret, or years later as styles and tastes change) with no damage to the walls or residue left behind.

It is also the case that wallpaper is costly—with traditional wallpaper having, at the time of the preparation of this disclosure, an average of between $0.018-0.025 costs per square inch. We have determined that the present costs of placement of the devices of the present invention costs, at the time of the preparation of this disclosure, in the neighborhood of $0.0071 per square inch for the product.

In the area of tiles for the placement on surfaces, it will be understood that various forms of tiles have been available on the market, including some that have some similar characteristics to the tiles of the present invention. Similar tiles having a more permanent type of mounting adhesive have been available for some time. These tiles have been designed to be affixed to a wall surface and then not removed at a later date. They are effectively permanent, in that the removal of such is found to be catastrophic to the surface upon which they are place; causing one who desired their removal to make extensive repairs, or replacement of the surface onto which they are placed. Additionally, due to the three-dimensional characters of the surfaces of these old-style tiles, covering such with another surface covering, other than paint, has been found to be impossible, and painting only changes the color, but retains the design, that at a later date may be found to be of questionable taste, contemporaneously. Additionally, care must be taken by the consumer to properly align and register such tiles, if needed, in a one-time application, since there would be difficulty to initially remove and realign or register the tile without damaging the wall surface. As noted, upon removing the tile at a later date, the wall surface is most certainly to be damaged due to the aggressive adhesion of the adhesive used, and/or adhesive and tile residue, transferred to the wall surface, must be removed, typically by scraping that can cause additional damage.

While there have been “removable” tiles in the past, there are issues found with those as well. Other commercially available “removable” tiles typically have a single piece release liner covering the adhesive, typically a PSA. Such that the covering must be completely removed from the tile before affixing it to the wall. As such, great care must be used by the user to prevent premature contact of the tile, to the wall, while trying to align or register the tile. Too much contact by the adhesive during this alignment process will result in adherence of the tile, making minor adjustments difficult without the total removal of the entire tile from its position, and starting the process again. During this “trial-and-error” placement period, damage to the wall, damage to the tile and frustration of the consumer can result. In a worse-case scenario, the adhesive loses short term tack or long term adhesion if repositioned without the Crack N Peel liner.

Detrimental environmental issues are associated with the wall coverings of the prior art. The walls to which the tile will be affixed vary in temperature, from room temperature in living areas, to high temperatures for walls around stoves and force air furnace outlets, radiators and changing temperatures and moisture conditions for walls inside of bathrooms. Each environment has an effect of the tile system, including the tile and its adhesive. In order a tile to be placeable in any situation they must be made with certain considerations. The tile must be made of low or no humidity or water absorbing material. The tile must be made to withstand higher temperatures such that they are heat resistance and do not permit curling or swelling. In some applications, the tile material has to be grease and oil resistant, that is, not absorbing these constituents. In other applications, the tile must resist soaps and cleaning agents, be non-deforming, non-swelling and non-curling from the surface. The adhesive used on these tiles must resist these varied application environments, maintaining adhesion under high humidity, higher temperatures and edge ingression of soaps and cleaning agents.

Many wallpapers do not have these environmental resistance properties and are thus not recommended for similar applications. Permanent tiles may have the necessary resistance properties, by selection of the appropriate tile materials, but would damage the wall surface upon removal.

In the adhesive used for the tiles and paper of the present invention, there are several factors in adhesion, including but not limited to Tack that are contemplated in the choice thereof. “Tack” is described as a measure of how quickly an adhesive bond is formed when two surfaces are brought together with light pressure. The faster two surfaces bond, the higher the Tack. Oppositely, a lower Tack allows an adhesive film or tape to be placed and then removed and repositioned. Tack in adhesives, commonly regarded as its stickiness, is measured as the rate at which an adhesive “wets” out, or permeates, a bonding surface (the Pressure Sensitive Tape Council (PSTC) factors 5 and 6). Tack, then, is the property of an adhesive which enables it to form a bond of measurable strength (known as “bond strength”) immediately after the adhesive and the substrate are brought into contact under minimal pressure.

The property of Tack is sensitive to a variety of factors, including ambient temperature, the processing and the properties of the adhered-to surface; Tack is measured using a number of methods. The Pressure Sensitive Tape Council (PSTC) compiles statistics and data regarding Tack and the methods of achieving levels of Tack, into a reference publication each year, adding new testing methods and refining current methods. Three tests covered in this resource are the loop Tack test, the probe Tack test and the rolling ball Tack test. The commonly used loop Tack test (PSTC-16), involves forming a film loop with the coated adhesive facing the outer side of the loop. The loop is brought down on a surface of choice for a brief moment and is then lifted back up. The measured pull-back force is denoted as “loop Tack”. According to the American Society of Testing and Materials (ASTM) standard, Tack has been defined as “the property that enables an adhesive to form a bond of measurable strength with the surface of another material upon brief contact and under high pressure”. Implicit in that definition, is that the adhesive separates cleanly from the surface, without any macroscopic residue.

Accordingly, the designated “Tack” alone will give an instant bond, but won't keep the face stock material adhered for long. If a longer and tougher bond is desired, the level of adhesion needs to be developed. With a strong bond, it will require more shear force to remove the adhered tile, which makes high adhesion coatings PSAs unsuitable for delicate surface applications.

Bond development, that is the ability of the adhesive to remain in place over time, is generally, in wall coverings, designed to increase over a period of time to a maximum, specified level. The chemistry of the PSA, the polymers and additives used and the inherent viscosity of the dry PSA, influence and determine the bond development. Specifically, softer PSA polymers have a property called “cold flow,” which allows a PSA to spread and make better contact to the surface of the wall; usually over a short period of time. This is also called “wetting” of the PSA onto the wall surface. As the cold flow progresses, the contact of the PSA increases and the bond becomes higher. The maximum bond level is specified for each PSA and application requirement. Other factors also influence the cold flow, such as amount of PSA, weight, temperature at time of application, the method of use, the smoothness or texture of the wall surface, the surface energy of the PSA and the surface energy of the wall. If the amount of PSA is too low to flow into and fill the discontinuities (the hills and valleys) of a textured wall surface, the bond development will be lower than anticipated. If the temperature is too low, the PSA will be stiffer and may not cold flow as anticipated, reducing wetting and contact to the wall surface. If the temperature is too high, the PSA will be too soft or ‘liquid’ and not have good shear resistance, allowing the weight of the tile to move the tile from its initial placement, including lifting or stripping the tile from the wall surface. If the surface energies of the mating surfaces, wall and PSA, are similar, then cold flow progresses with good wetting to maximum contact. If the surface energies are too dissimilar, then cold flow may not reach good wetting and the bond will be lower than anticipated. If surface energies are too dissimilar, there may still be good cold flow and wetting, but the adhesion of the PSA to the wall surface can be less than anticipated.

“Peel” is a measure of the force needed to break the bond between an adhesive and the surface it has been applied to. This determines the strength of the bond. Peel determines the strength of the bond. In peel testing, an adhesive-coated specimen is applied to a test panel or against another adhesive specimen and allowed to sit, for a designated period, before being pulled away. For consistency of results, the testing parameters, such as direction of Peel (at a straight or right angle), application rate of pressure, between the subject and surface, and the dwell time, are standardized based on bond type and intended performance measurement. These standards are provided both by PSTC (PSTC-101 Peel Adhesion Test) and ASTM International (ASTM D3330—Standard Test Method for Peel Adhesion, ASTM D6252—Standard Test Method for Peel Adhesion at 90° Angle, ASTM D903—Standard Test Method for Peel or Stripping Strength, and ASTM D1876—Standard Test Method for Peel Resistance).

“Shear” is the ability of a material to resist lateral forces that cause it to slide against itself and can be thought of as one surface sliding over another. In a shear test, an adhesive-coated specimen is mounted vertically with a given weight attached. Shear is measured by the time required for the weight to cause the specimen to come loose, demonstrating the durability of a bond; slip a predetermined distance or remain in place with no movement for a predetermined length of time, demonstrating the durability of a bond. Different temperatures, humidity and other parameters can be applied in such tests. Shear tests are standardized by PSTC-107 Shear Adhesion of Pressure Sensitive Tape, as well as by multiple standards from ASTM International, depending on the substrates and application.

Therefore, in a preferred embodiment, a section of tile or wallpaper of the present invention will be sized at either 11″×16″ and 16″×24″, have material of generally 3.92 mil vinyl face stock and a liner of generally 3.92 mil clear PET liner, which liner doubles as packaging for the section; the element will have a “crack & peel” die cut liner that allows for easy liner removal and wall application, as disclosed herein and a preferred adhesive of Aroset™ 301, manufactured by Bostik Inc. of Wauwatosa, Wisconsin. The complete tile piece will typically be between 10 mil and 12 mil in thickness. A graphical representation of the specification for this adhesive, which is an acrylic emulsion is provided below. It will be understood that other adhesives, having similar properties, both chemical and water solvent can be substituted without departing from the novel scope of the present invention. The below specification is provided for informational purposes. The below chart shows a combination of physical, formulation and coating specifications required for an adhesive to be used on wall decor and wallpaper products that achieves the performance specifications of a preferred embodiment of the present invention.

SPECIFICATIONS FOR A PREFERRED ADHESIVE FOR
USE AS PART OF THE PRESENT INVENTION.
(Pressure Sensitive Adhesive - Technical Data Sheet)
PSA TDS -

| Substrate | Property | Value | | Units |
|---|---|---|---|---|
| Wall Tile | Basis Weight | 135 | +/− 5 | Lb./3300 sq. ft. ream |
| | | 123 | +/− 5 | Lb./3300 sq. ft. ream |
| | Caliper | 0.010 | +/− 0.0005 | inch |
| Wallpaper | Basis Weight | 80 | +/− 0.5 | Lb./3300 sq. ft. ream |
| | | 73 | +/− 90.5 | Lb./3000 sq. ft. ream |
| | Caliper | 0.010 | +/− 0.0005 | inch |

| | |
|---|---|
| To be coated | Siliconized paper or siliconized BOPET |

PSA Specification

| Property | Value | Units | Alternate Units |
|---|---|---|---|
| Categorical/Classification | Acrylic emulsion | Solvent | |
| Solids | 50-55 | % non volatile | |
| pH | 4.0-8.0 | | |
| Coating Method - Gravure; | Gravure; Dahlgren coater | | |
| Dahlgren coater | | | |
| Viscosity | 50-800 | centipoise | |
| Applied weight | 10 | Lb./3000 sq. ft. ream | 11.0 lb./ |
| | (0.0231) | (Lb./MSI) | 3000 sq. ft. ream |
| | 13 | Lb./3000 sq. ft. ream | 14.3 lb./ |
| | (0.030) | (Lb./MSI) | 3000 sq. ft. ream |
| | 16 | Lb./3000 sq. ft. ream | 17.6 lb./ |
| | (0.087) | (Lb./MSI) | 3000 sq. ft. ream |
| Glass Transition (Tg) | −30 to −40 | ° C. | |
| Dry Appearance | Water clear to slight haze | | |
| Removal Ghosting | none | | |
| Stain Resistance for Finishes | no staining | | |
| Prop 65 compliant | yes | | |
| REACH compliant | Desirable | | |

Performance Properties
1 m8 PSA Applied to 1 mil Polyester and Tested on #304 Stainless Steel #3 Finish

| | | | |
|---|---|---|---|
| 180° | Peel Adhesion | 1.0 to 2.5 | Lb./inch |
| 90° | Peel Adhesion | 0.5 to 1.5 | Lb./inch |
| 178° | Shear Adhesion | 250 to 500 | minutes |

| | | |
|---|---|---|
| Loop Tack | 0.5 to 1.0 | Lb./inch |
| Minimum applicaiton temperature | 32 | ° F. |
| Service Temperature Range | 20 to 250 | ° F. |

Volume Calculation

| | |
|---|---|
| 1 3000 sq. ft. ream = 432 MSI | 1 3300 sq. foot ream = 475.2 MSI |

(1) Total MSI to be coated X applied dry weight per MSI/per
(2) Total reams to be coated X applied dry weight per ream/

Although the present partial peel-away feature has only been shown and described herein with the wallpaper 2 version of the covering, it can absolutely be utilized with the wall tile 1 in the same fashion. It should be further noted that the partial peel-away strip 10 is shown as a elongated rectangle taking on the form of the overall wallpaper 2, this partial peel-away could be configured on the covering in other manners, such as just a corner of the covering [I the shape of a triangle], it could be circular in the middle of the backside of the covering, it could be wherever it makes sense and facilitates the easy peel-away and temporary application of the covering or for manufacturing purposes and the like.

While the present invention has been shown and described in the figures, it is capable of embodiment in various forms, and there is described herein the presently preferred and known alternative embodiments. It should be understood that the present disclosure is to be considered as an exemplification of the present invention, and is not intended to limit the invention to the specific embodiments discussed or illustrated. Although illustrative embodiments of the invention have been shown and described, it is to be understood that various modifications and substitutions may be made by those skilled in the art without departing from the novel spirit and scope of the invention.

Although an illustrative embodiment of the invention has been shown and described, it is to be understood that various modifications and substitutions may be made by those skilled in the art without departing from the novel spirit and scope of the invention.

What is claimed is:

1. A panel for covering a surface, comprising:
a decorative cover portion as a front for displaying on a surface;
an adhesive portion, applied to the back of the cover portion;
a removable adhesive protection cover, protecting the adhesive portion from permanent attachment to a surface before adhesion is desired;
wherein, the adhesive protection cover is made in two parts, a general surface cover for protection of substantially all of the back of the panel and a strip portion, covering the remainder of the back panel and which can be removed from the panel, independent of the general surface cover, to expose only a small portion of adhesive.

2. The panel for covering a surface of claim 1, wherein the surface is a wall.

3. The panel for covering a surface of claim 1, wherein the adhesive is a press and apply type of adhesive.

4. The panel for covering a surface of claim 1, wherein the panel is comprised of wallpaper.

5. The panel for covering a surface of claim 1, wherein the panel is a tile.

6. The tile of claim 5, wherein the tile has a thickness of between 10 mil and 12 mil.

7. The panel for covering a surface of claim 1, wherein the panel is registered to permit the proper placement of a design made from two or more panels.

8. The panel for covering a surface of claim 1, wherein the adhesive protective cover is a siliconized release liner and comprises a crack and peel portion to allow only a small section of adhesive to be revealed such that the panel can be temporarily placed on a surface and subsequently removed therefrom.

9. The panel for covering a surface of claim 1, wherein the adhesive used has a lower tack and is a low Surface Energy silicone.

10. The panel for covering a surface of claim 1, wherein the panel is sized at either 11″×16″ or 16″×24″, has a generally 3.92 mil vinyl face stock and a liner of generally 3.92 mil clear PET liner.

11. The panel for covering a surface of claim 1, wherein the adhesive protection cover comprises part of the retail packaging for the panel.

12. The panel for covering a surface of claim 11, wherein the adhesive protection cover comprises a listing of instructions, including instructions for the placement of the panel on a surface.

13. A panel for covering a wall, comprising:
a registered decorative cover portion as a front for displaying on a surface;
an adhesive portion, comprising a lower tack press and apply type adhesive, applied to the back of the cover portion;
an adhesive protection cover, protecting the adhesive portion from permanent attachment to a surface before adhesion is desired and comprises a surface of the retail packaging for the panel;
wherein, the adhesive protection cover is made in two parts, a general surface cover for protection of substantially all of the back of the panel and a strip portion, created as a crack and peel strip, covering the remainder of the back panel and which can be removed from the panel, independent of the general surface cover, to expose only a small portion of adhesive.

14. The panel for covering a surface of claim 13, wherein the panel is comprised of wallpaper.

15. The panel for covering a surface of claim 13, wherein the panel is a vinyl tile.

16. The vinyl tile of claim 15, where in the tile has a thickness of between 3 mil and 5 mil.

17. The panel for covering a surface of claim 11, wherein the panel is sized at either 11″×16″ or 16″×24″, has a generally 3.92 mil vinyl face stock and a liner of generally 3.92 mil clear PET liner.

18. The panel for covering a surface of claim 13, wherein the adhesive protection cover comprises a listing of instructions for placement of the panel on a surface.

19. The panel for covering a surface of claim 1, wherein the adhesive protection cover comprises a siliconized release liner.
